(19) United States
(12) Patent Application Publication
(10) Pub. No.: US 2021/0336696 A1
(43) Pub. Date: Oct. 28, 2021

(54) LIGHT SOURCE SEPARATION METHOD, LIGHT SOURCE SEPARATION DEVICE AND LIGHT SOURCE SEPARATION PROGRAM

(71) Applicant: Nippon Telegraph and Telephone Corporation, Tokyo (JP)

(72) Inventors: Mitsuki NAKAMURA, Tokyo (JP); Wataru YAMADA, Tokyo (JP); Yasushi TAKATORI, Tokyo (JP)

(21) Appl. No.: 17/289,190

(22) PCT Filed: Oct. 21, 2019
(86) PCT No.: PCT/JP2019/041291

§ 371 Date: Apr. 27, 2021

(30) Foreign Application Priority Data
Oct. 29, 2018 (JP) 2018-202850

(51) Int. Cl. H04B 10/116

(52) U.S. Cl. CPC H04B 10/116

(57) ABSTRACT

A light source separation method of separating light sources in a communication system performing visible-light communication in which information is transmitted by changing luminance of the light sources includes: acquiring luminance information of a communication area; dividing the communication area into a plurality of segments based on the luminance information; separating each light source performing the visible-light communication based on a luminance variation pattern of each segment; and converting light from the light source separated in the separating into a reception signal and outputting the reception signal.

### TECHNICAL FIELD

The present invention relates to a technology for separating each light source when there are a plurality of light sources in communication using visible light.

### BACKGROUND ART

In the field of radio communication, communication using visible light in a higher frequency band than that of radio waves (referred to as visible-light communication) has been examined due to shortage of frequency resources used for radio communication. Visible-light communication is, for example, communication in which information is transmitted by blinking light, and a method of using visible-light communication in combination with a light source of an illumination device and the like has been examined (for example, see Patent Literature 1).

### CITATION LIST

### Patent Literature

Patent Literature 1: JP 2013-29799 A

### SUMMARY OF THE INVENTION

### Technical Problem

Incidentally, a plurality of illumination devices can be installed in the same space, and thus there is a problem that it is difficult to separate each communication destination light source. In the case of indirect illumination, light from a light source is radiated via a reflection surface, and thus the light source may not directly be observed. When there are a plurality of light sources, it is difficult to identify signals. Thus, in a communication system in which a light source of an illumination device is used for visible-light communication, there is a problem that it is difficult to separate each light source when a plurality of light sources coexist or a light source cannot directly be observed.

An objective of the present invention is to provide a light source separation method, a light source separation device, and a light source separation program capable of separating each light source when a plurality of light sources coexist or a light source cannot directly be observed in a communication system performing visible-light communication in which luminance of a light source is changed to transmit information.

### Means for Solving the Problem

According to a first aspect of the present invention, a light source separation method of separating light sources in a communication system performing visible-light communication in which information is transmitted by changing luminance of the light sources includes: acquiring luminance information of a communication area; dividing the communication area into a plurality of segments based on the luminance information; separating each light source performing the visible-light communication based on a luminance variation pattern of each segment; and converting light from the light source separated in the separating into a reception signal and outputting the reception signal.

A second aspect of the present invention is the light source separation method according to the first aspect of the present invention, wherein, in the dividing, the communication area is divided into the plurality of segments by performing, on the entire communication area, processing of dividing the communication area into small mesh-like areas and integrating small adjacent areas having similar luminance variation patterns.

According to a third aspect of the present invention, a light source separation device configured to separate light sources in a communication system performing visible-light communication in which information is transmitted by changing luminance of the light sources includes: a luminance acquisition unit configured to acquire luminance information of a communication area; an area dividing unit configured to divide the communication area into a plurality of segments based on the luminance information; a light source separation unit configured to separate each light source performing the visible-light communication based on a luminance variation pattern of each segment; and a light signal conversion unit configured to convert light from the light source separated by the light source separation unit into a reception signal and output the reception signal.

A fourth aspect of the present invention is the light source separation method according to the third aspect of the present invention, wherein the area dividing unit divides the communication area into the plurality of segments by performing, on the entire communication area, processing of dividing the communication area into small mesh-like areas and integrating adjacent small areas having similar luminance variation patterns.

A fifth aspect of the present invention is a light source separation program causing a computer to perform processing performed in the light source separation device according to the third or fourth aspect of the present invention.

### Effects of the Invention

A light source separation method, a light source separation device, and a light source separation program according to the present invention are capable of separating each light source when a plurality of light sources coexist or a light source cannot directly be observed in a communication system performing visible-light communication in which luminance of a light source is changed to transmit information.

### BRIEF DESCRIPTION OF DRAWINGS

FIG. 1 is a diagram illustrating an example of a light source separation device according to the present embodiment.

FIG. 2 is a diagram illustrating an example of a light source separation method.

FIG. 3 is a diagram illustrating a state in which a communication illumination device is viewed from an oblique angle.

FIG. 4 is a diagram illustrating an example of the light source separation device.

FIG. 5 is a diagram illustrating the light source separation method in the light source separation device according to the present embodiment.

FIG. 6 is a diagram illustrating examples of luminance variation patterns.

FIG. 7 is a diagram illustrating a flowchart of the light source separation method.

### DESCRIPTION OF EMBODIMENTS

Hereinafter, embodiments of a light source separation method, a light source separation device, and a light source separation program according to the present invention will be described with reference to the drawings. Here, the light source separation method, the light source separation device, and the light source separation program according to the present invention are capable of separating each communication destination light source from a plurality of light sources and performing communication when visible-light communication in which luminance of the light source is changed to transmit information is performed under the environment in which a plurality of light sources of illumination devices coexist.

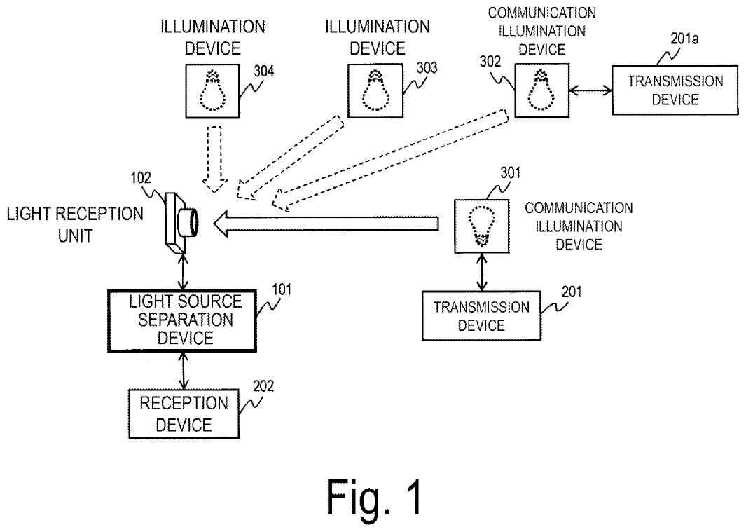

FIG. 1 is a diagram illustrating an example of a light source separation device 101 according to the present embodiment. In FIG. 1, a transmission device 201 and a reception device 202 perform visible-light communication. Here, the reception device 202 may perform communication with a plurality of transmission devices such as a transmission device 201a that has a similar function to the transmission device 201. In FIG. 1, to facilitate a description, a light reception unit 102 and a light source separation device 101 will be described as separate devices from the reception device 202, but the light reception unit 102 and the light source separation device 101 may be embedded in the reception device 202.

In FIG. 1. the transmission device 201 modulates light from a light source unit of a communication illumination device 301 and transmits data. Here, the light source unit of the communication illumination device 301 needs to illuminate the surroundings with visible light as a normal illumination device. Thus, modulation for transmitting data is assumed to be performed in such a manner that the modulation is difficult to perceive with human eyes. For example, the light source blinks to perform modulation at a high speed at a very short time interval in accordance with “1” and “0” of a digital signal.

In this way, light radiated from the light source unit of the communication illumination device 301 is received by the light reception unit 102. The light source separation device 101 performs processing of separating light received by the light reception unit 102 into light from each light source. In the example of FIG. 1, a plurality of light sources radiating visible light, such as a light source of a communication illumination device 302 of the transmission device 201a and light sources of normal illumination devices 303 and 304, in addition to the light source of the communication illumination device 301 of the transmission device 201, are located in the periphery of the light reception unit 102. The light source separation device 101 separates a light beam of each of the plurality of light sources from the light received by the light reception unit 102, converts the received light signal of each light source into a digital signal of “1” and “0,” and outputs the digital signal to the reception device 202. Here, the light reception unit 102 includes, for example, an image sensor capable of acquiring a blinking pattern of received light as a 2-dimensional image or a digital camera including such an image sensor.

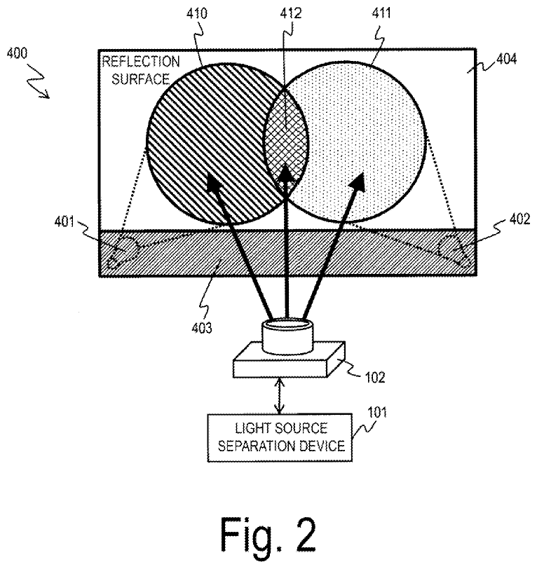

FIG. 2 is a diagram illustrating an example of the light source separation method. In the example of FIG. 2, one communication illumination device 400 includes two visible-light communication light sources, which are light source units 401 and 402 performing different communications. The light source units 401 and 402 are hidden by an illumination cover 403, and the light reception unit 102 cannot directly observe the light source units 401 and 402. Light radiated from the light source units 401 and 402 can be received by the light reception unit 102 as light reflected from a reflection surface 404 of the communication illumination device 400.

In FIG. 2, light radiated from the light source unit 401 illuminates a circular area 410 on the reflection surface 404 and is reflected toward the light reception unit 102. Similarly, light radiated from the light source unit 402 illuminates a circular area 411 on the reflection surface 404 and is reflected toward the light reception unit 102. Here, in the example of FIG. 2, both the light radiated from the light source unit 401 and the light radiated from the light source unit 402 illuminate a foliated area 412 in which the areas 410 and 411 overlap each other. Thus, both the light radiated from the light source unit 401 and the light radiated from the light source unit 402 are mixed in the area 412, and the mixed light from the area 412 is received by the light reception unit 102. The light reception unit 102 captures an image of luminance information of the reflection surface 404 as a 2-dimensional image (a moving image), for example, as in a digital camera and outputs the luminance information to the light source separation device 101. The light source separation device 101 analyzes the image acquired from the light reception unit 102, identifies, for example, light reflected from the reflection surface 404, and separates a light signal from the light source unit 401 from a light signal from the light source unit 402. A light source separation method will be described in detail later.

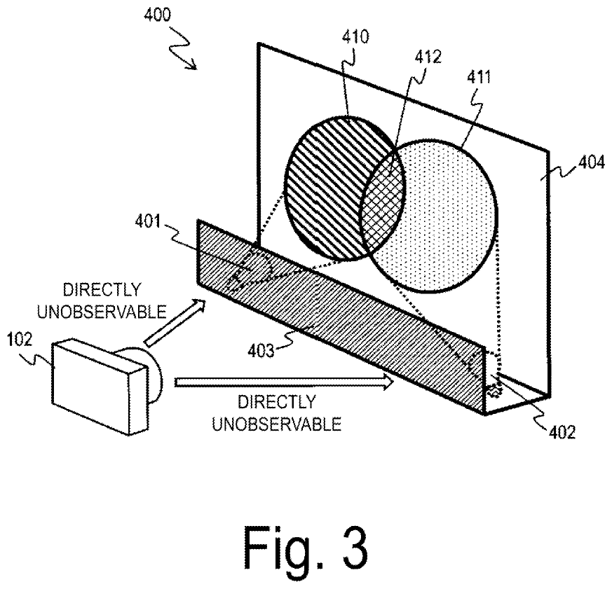

FIG. 3 is a diagram illustrating a state in which the communication illumination device 400 illustrated in FIG. 2 is viewed from an oblique angle. Because the communication light source units 401 and 402 are hidden by the illumination cover 403, the light from the light source units 401 and 402 is not directly observable from the light reception unit 102.

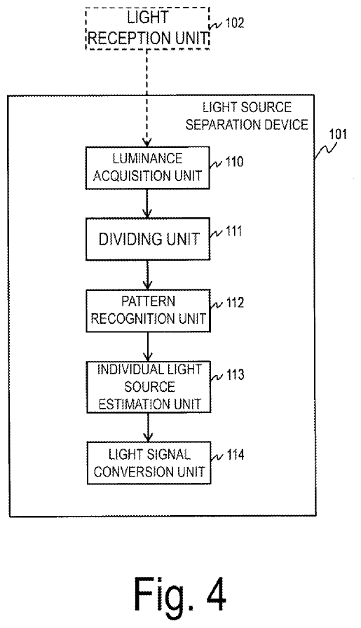

FIG. 4 is a diagram illustrating an example of the light source separation device 101. Here, the light source separation device 101 is a device that separates light sources for visible-light communication in which luminance of each light source is changed to transmit information. In FIG. 4, the light source separation device 101 includes a luminance acquisition unit 110, a dividing unit 111, a pattern recognition unit 112, an individual light source estimation unit 113, and a light signal conversion unit 114.

The luminance acquisition unit 110 acquires, from the light reception unit 102, luminance information (luminance data) of a surrounding communication area where communication is possible. Here, when the light reception unit 102 is a digital camera, an image captured by the light reception unit 102 is acquired.

The dividing unit 111 first divides the image acquired by the luminance acquisition unit 110 into small mesh-like areas with predetermined sizes. Here, the size of the small areas may be, for example, an area of 8×8 pixels or may be an area of 16×16 pixels. Alternatively, one pixel may be one small area. Further, among the adjacent small areas, small areas having similar luminance information are integrated by the dividing unit 111, so that the image area is divided into a plurality of segments. For example, the dividing unit 111 perform, on the entire area, processing of comparing the luminance information such as luminance values or luminance variation patterns of the adjacent small areas to obtain similarity and integrating small areas in which the similarity is equal to or greater than a predetermined threshold. This enables the image area to be divided into a plurality of segments. Here, when one small area includes a plurality of pixels such as 8×8 pixels, an average value of the plurality of pixels is used as a luminance value of the small area.

The pattern recognition unit 112 recognizes a luminance variation pattern of each of the plurality of segments resulting from the division by the dividing unit 111. Here, the luminance variation pattern is recognized based on at least one piece of information such as a time interval at which light is turned on or off, a period, and a luminance level.

The individual light source estimation unit 113 separates the light sources based on the luminance variation patterns of the respective segments. Here, examples of the luminance variation patterns will be described in detail later.

The light signal conversion unit 114 converts the received light of each light source separated by the individual light source estimation unit 113 of each segment into a digital signal and outputs the digital signal to the reception device 202.

In this way, the light source separation device 101 according to the present embodiment can separate the light signals received from the plurality of light sources from the light received by the light reception unit 102 based on the variation patterns of the light from the plurality of light sources. This enables a plurality of visible-light communications to be operated simultaneously.

Here, the light source separation device 101 according to the present embodiment has been described as a device that has each block illustrated in FIG. 4. However, the light source separation device 101 can be implemented by a computer that executes a program corresponding to processing performed by each block. The program may be provided by being recorded on a recording medium or may be provided via a network.

Next, a method of separating each light source in an environment in which light is received from a plurality of light sources will be described.

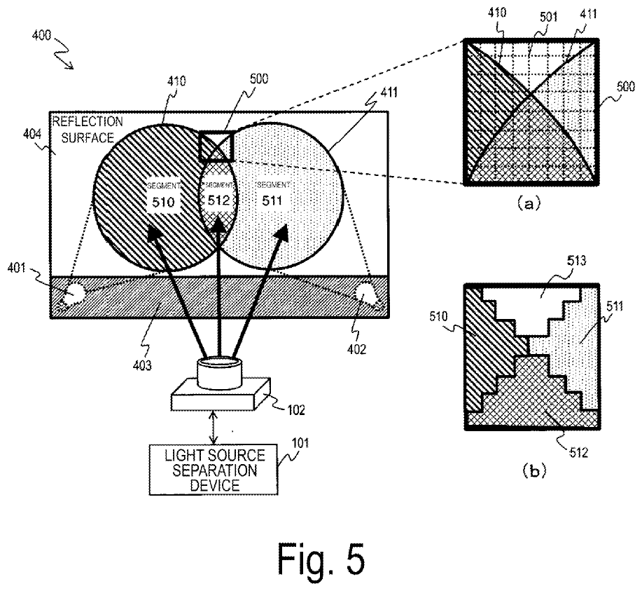

FIG. 5 is a diagram illustrating the light source separation method in the light source separation device 101 according to the present embodiment. Here, FIG. 5 is a diagram corresponding to FIG. 2 and portions with the same reference numerals as those of FIG. 2 are the same portions as in FIG. 2.

In FIG. 5, an area of the reflection surface 404 illuminated with only light from the light source unit 401 is assumed to be a segment 510, an area of the reflection surface 404 illuminated with only light from the light source unit 402 is assumed to be a segment 511, and an area of the reflection surface 404 illuminated with both the light from the light source unit 401 and the light from the light source unit 402 is assumed to be a segment 512.

The light source separation device 101 according to the present embodiment acquires luminance information (herein referred to as moving image data of a 2-dimensional image) from the light reception unit 102 and divides the entire acquired image area into a plurality of small mesh-like areas. FIG. 5(a) illustrates a state in which a portion in a frame 500 in FIG. 5 is divided into a plurality of small areas by a mesh 501. In the example of FIG. 5(a), the portion is vertically divided into 8 areas and horizontally divided into 8 areas. Thus, the portion is divided into 64 small areas.

FIG. 5(b) illustrates a state in which, of the divided small areas in FIG. 5(a), the adjacent small areas are integrated in accordance with similarity of the luminance information. For example, the light source separation device 101 repeatedly performs, on the entire area, processing of obtaining similarity based on the luminance information such as luminance values or luminance variation patterns of the adjacent small areas and integrating small areas in which the similarity is equal to or greater than the predetermined threshold. In this way, the light source separation device 101 according to the present embodiment can divide the entire 2-dimensional image into a plurality of segments in which the luminance information such as luminance values or luminance variation patterns is similar. In the example of FIG. 5(b), the portion in the frame 500 is divided into four segments of the segments 510, 511, 512, and 513 by the above-described method.

In this way, the light source separation device 101 according to the present embodiment can divide the image into the segment 510 illuminated with only the light from the light source unit 401, the segment 511 illuminated with only the light from the light source unit 402, the segment 512 illuminated with both the light from the light source unit 401 and the light from the light source unit 402, and the segment 513 illuminated with no light.

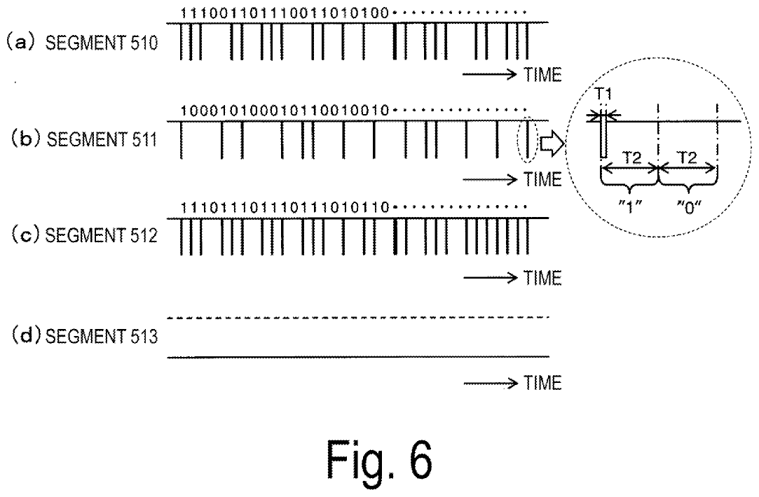

FIG. 6 is a diagram illustrating examples of the luminance variation patterns. Here, the variation patterns illustrated in FIG. 6 are examples of temporal changes in the luminance values of the areas corresponding to the segments of the 2-dimensional image acquired by the light reception unit 102. The luminance value of the area corresponding to each segment may be, for example, an average value of the luminance values of all the pixels of each segment or may be an average value of a plurality of pixels near the center of the segment.

FIG. 6(a) illustrates a change in luminance in the area of the segment 510 described in FIG. 5. Similarly, FIGS. 6(b), 6(c), and 6(d) illustrate changes in luminance of the areas of the segments 511, 512, and 513 described in FIG. 5.

Here, the luminance variation patterns illustrated in FIG. 6 indicate patterns turning on/off of the light sources. The light sources are turned off for only a minute period T1 which human eyes cannot perceive. For example, a pulse of the minute period T1 within a predetermined period T2 indicates a digital signal of “1”. No pulse within the predetermined period T2 indicates a digital signal of “0”. In this way, by turning on and off each light source of the illumination device according to a predetermined rule, it is possible to transmit and receive the digital signal. For example, in the case of FIG. 6(a), the variation pattern of the light received in the area of the segment 510 is converted into a digital signal of “111001101110011010100 . . . .” Similarly, in the case of FIG. 6(b), the variation pattern of the light received in the area of the segment 511 is converted into a digital signal of “100010100010110010010 . . . .” In the case of FIG. 6(c), the variation pattern of the light received in the area of the segment 512 is converted into a digital signal of “111011101110111010110 . . . .” In the case of FIG. 6(d), the variation pattern is converted into a digital signal of all “1”s because no light is received from any light source in the area of the segment 513, as illustrated in FIG. 5.

In this way, even when light from a plurality of light sources is mixed, the light source separation device 101 according to the present embodiment can divide a communication area into a plurality of segments each having a similar luminance variation pattern, separate received light into light of each segment, convert the light into a separate digital signal, and output the digital signal. In the examples of FIGS. 5 and 6, apart from the segment 510 receiving the light from the light source unit 401 and the segment 511 receiving the light from the light source unit 402, the light of the segment 512 is also separated and converted into a digital signal, and the digital signal is output to the reception device 202. However, the reception device 202 can identify and receive a signal of a desired communication destination. For example, the reception device 202 can identify a signal of a desired communication destination based on a signal determined in advance for each communication destination (a preamble signal, a header signal, or the like added to each data block). For example, the light received in the segment 512 in FIG. 6(c) is light in which both the light from the light source unit 401 and the light from the light source unit 402 are mixed, as illustrated in FIG. 5. Therefore, even when a signal is output from the light source separation device 101 to the reception device 202, the reception device 202 determines that this signal is not a signal of a desired communication destination and eliminates the signal.

Next, a flowchart of processing of the light source separation method of the above-described light source separation device 101 will be described.

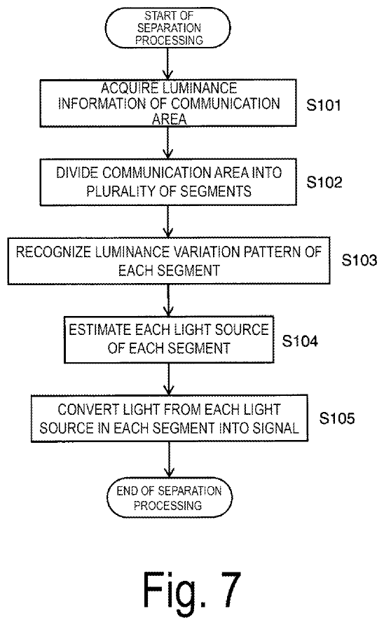

FIG. 7 is a diagram illustrating a flowchart of the light source separation method. The processing of FIG. 7 is performed by, for example, each unit of the light source separation device 101 described in FIG. 4.

In step S101, the luminance acquisition unit 110 acquires, from the light reception unit 102, luminance information such as an image of a surrounding communication area where communication is possible.

In step S102, the dividing unit 111 divides the entire image area acquired in step S101 into small mesh-like areas with predetermined sizes and integrates adjacent small areas having similar luminance information. This allows for division of the entire image area into a plurality of segments.

In step S103, the pattern recognition unit 112 recognizes a luminance variation pattern in each of the plurality of segments resulting from the division in step S102.

In step S104, the individual light source estimation unit 113 estimates each communication destination light source performing visible-light communication based on the luminance variation pattern of each segment.

In step S105, the light signal conversion unit 114 converts the light of each of the segments into a light signal of each light source separated in step S104.

In this way, according to the light source separation method according to the present embodiment, it is possible to identify the light from each of the plurality of light sources from the light received by the light reception unit 102 and separate the light into the light signal received from each light source. Therefore, a plurality of visible-light communications can be operated simultaneously.

As described in the embodiments above, the light source separation method, the light source separation device, and the light source separation program according to the present invention are capable of separating each light source even when a plurality of light sources coexist or a light source cannot directly be observed in the visible-light communication.

### REFERENCE SIGNS LIST

101 Light source separation device
102 Light reception unit
110 Luminance acquisition unit
111 Dividing unit
112 Pattern recognition unit
113 Individual light source estimation unit
114 Light signal conversion unit
201, 201a Transmission device
301, 302 Communication illumination device
303, 304 Illumination device
401, 402 Light source unit
403 Illumination cover

1. A light source separation method of separating light sources in a communication system performing visible-light communication in which information is transmitted by changing luminance of the light sources, the light source separation method comprising:
acquiring luminance information of a communication area;
dividing the communication area into a plurality of segments based on the luminance information;
separating each light source performing the visible-light communication based on a luminance variation pattern of each segment of the plurality of segments; and
converting light from the separated light source into a reception signal and outputting the reception signal.

2. The light source separation method according to claim 1, wherein, in the dividing, the communication area is divided into the plurality of segments by performing, on the entire communication area, a process of dividing the communication area into small mesh-like areas and integrating adjacent small areas having similar luminance variation patterns.

3. A light source separation device configured to separate light sources in a communication system performing visible-light communication in which information is transmitted by changing luminance of the light sources, the light source separation device comprising:
a luminance acquisition unit, including one or more processors, configured to acquire luminance information of a communication area;
an area dividing unit, including one or more processors, configured to divide the communication area into a plurality of segments based on the luminance information;
a light source separation unit, including one or more processors, configured to separate each light source performing the visible-light communication based on a luminance variation pattern of each segment of the plurality of segments; and
a light signal conversion unit, including one or more processors, configured to convert light from the light source separated by the light source separation unit into a reception signal and output the reception signal.

4. The light source separation device according to claim 3, wherein the area dividing unit divides the communication area into the plurality of segments by performing, on the entire communication area, a process of dividing the communication area into small mesh-like areas and integrating adjacent small areas having similar luminance variation patterns.

5. A non-transitory computer readable medium storing one or more instructions causing a computer to execute:
acquiring luminance information of a communication area, in a communication system performing visible-light communication in which information is transmitted by changing luminance of the light sources;
dividing the communication area into a plurality of segments based on the luminance information;
separating each light source performing the visible-light communication based on a luminance variation pattern of each segment of the plurality of segments; and
converting light from the separated light source into a reception signal and outputting the reception signal.

6. The non-transitory computer readable medium according to claim 5, wherein the one or more instructions further cause the computer to execute:
dividing, the communication area into the plurality of segments by performing, on the entire communication area, a process of dividing the communication area into small mesh-like areas and integrating adjacent small areas having similar luminance variation patterns.
